(19) United States
(12) Patent Application Publication
(10) Pub. No.: US 2016/0276735 A1
(43) Pub. Date: Sep. 22, 2016

(54) BLUETOOTH ANTENNA OF COMMON RF COAXIAL CABLE AND ITS COMMUNICATION TERMINAL

(71) Applicant: SPREADTRUM COMMUNICATIONS (SHANGHAI) CO., LTD., Pudongxinqu, Shanghai (CN)

(72) Inventors: Zhongping SUN, Pudongxinqu, Shanghai (CN); Bei NI, Pudongxinqu, Shanghai (CN); Wulin SHI, Pudongxinqu, Shanghai (CN); Ruzhong LIU, Pudongxinqu, Shanghai (CN)

(73) Assignee: SPREADTRUM COMMUNICATIONS (SHANGHAI) CO., LTD., Pudongxinqu, Shanghai (CN)

(21) Appl. No.: 14/396,957

(22) PCT Filed: Dec. 13, 2013
(86) PCT No.: PCT/CN2013/089401

§ 371 Date: Oct. 24, 2014

(51) Int. Cl. H01Q 1/22; H01Q 1/36; H01Q 1/48; H01Q 1/24

(52) U.S. Cl. CPC H01Q 1/2291; H01Q 1/243; H01Q 1/36; H01Q 1/48

(57) ABSTRACT

The present invention discloses A Bluetooth antenna of common RF coaxial cable, comprising: a RF coaxial cable including a first RF interface and a second RF interface, two ends of the RF coaxial cable are respectively connected to the first RF interface and the second RF interface, the RF coaxial cable is provided with a feed point. The present invention takes the outer conductor as the radiator of the Bluetooth antenna. The Bluetooth antenna can be worked with the RF coaxial cable at the same time, which decreases the size of the antenna and achieve the goal of decreasing the size of the whole communication terminal.

### TECHNICAL FIELD

The present invention relates to a communication device, more specifically, to a Bluetooth antenna of common RF coaxial cable 2 and its communication terminal.

### BACKGROUND OF THE INVENTION

Bluetooth is a radio communication technique with low-cost and low-power consumption which supports a short distance communication (normally within 10 m) between the devices, employs the dispersed networks structures and shot package technology, and supports point-to-point and point-to-multipoint communication and works at the universal coordinated frequency band 2.4 GHz ISM (i.e., Industry, Science, Medicine), its data transfer speed is 1 Mbps. Since Bluetooth possesses the advantages of long-distance transferring, fast transferring speed and low-power consumption, the Bluetooth technique still would be the preferred short-distance radio transfer standard.

Antenna is the key assembly except the core system chip in the Bluetooth module, which influences the transfer characteristic of the Bluetooth. In various Bluetooth application products, the antenna design and its producing material are not identical. The most common antenna includes Dipole Antenna, Planar Inverted F Antenna, Monopole Antenna and Ceramic Antenna and so on.

With the development of the manufacturing technique and the consumer demands, the mobile terminals (such as mobile phones, laptops) design tends to be more slim and tiny. Meanwhile, the radio transfer (including voice and data transfer) becomes the indispensable function for various mobile terminals. With the decreasing size of the mobile terminals and adapting various radio transfer protocols, multiple antenna had to be configured in a limited space, in this case the antenna design becomes more difficult. Thus the key point of mobile terminals design is to decrease the antenna size without lowering its working performance.

### SUMMARY OF THE INVENTION

Due to the defects existing in the prior art, a Bluetooth antenna of common RF coaxial cable which decreases the size of the antenna and being free from lowering its working performance.

The present invention is achieved by the following technical solutions:

According to one aspect of the present invention, a Bluetooth antenna of common RF coaxial cable is provided, wherein:

a RF coaxial cable including a first RF interface and a second RF interface, two ends of the RF coaxial cable are respectively connected to the first RF interface and the second RF interface, the RF coaxial cable is provided with a feed point.

The above-mentioned Bluetooth antenna of common RF coaxial cable, wherein the total length of the RF coaxial cable is odd times of one quarter of the Bluetooth resonant wavelength, preferably, the total length of the RF coaxial cable is odd times of three-quarters of the Bluetooth resonant wavelength.

The above-mentioned Bluetooth antenna of common RF coaxial cable, wherein the distance from the feed point to the first RF interface is even times of one quarter of the Bluetooth resonant wavelength, preferably, the distance from the feed point to the first RF interface is one half of the Bluetooth resonant wavelength.

The above-mentioned Bluetooth antenna of common RF coaxial cable, wherein the distance from the feed point to the second RF interface is odd times of one quarter of the Bluetooth resonant wavelength, preferably, the distance from the feed point to the second RF interface is one quarter of the Bluetooth resonant wavelength.

The above-mentioned Bluetooth antenna of common RF coaxial cable, wherein the structure of the RF coaxial cable is consisted of an inner conductor, an inner insulator, an outer conductor and an outer insulator from the inside out.

The above-mentioned Bluetooth antenna of common RF coaxial cable, wherein the outer conductor is provided with two ground connection.

The above-mentioned Bluetooth antenna of common RF coaxial cable, wherein the outer conductor is connected to the ground at the joint of the first RF interface and the joint of the second RF interface respectively.

The above-mentioned Bluetooth antenna of common RF coaxial cable, wherein the feed point is connected to the outer conductor.

The above-mentioned Bluetooth antenna of common RF coaxial cable, wherein the RF coaxial cable is placed on a PCB with a rectangle shape, the first RF interface is adjacent to the corner of the PCB.

In another aspect of the present invention, a communication terminal is provided, wherein it comprises the above-mentioned Bluetooth antenna of common RF coaxial cable.

The advantageous effects of the above technical solution are as but not limited to: the present invention takes the outer conductor as the radiator of the Bluetooth antenna; the RF coaxial cable can still be utilized for transferring RF signal, so that the Bluetooth antenna can be worked with the RF coaxial cable at the same time, which decreases the size of the antenna and achieve the goal of decreasing the size of the whole communication terminal.

### BRIEF DESCRIPTIONS OF THE DRAWINGS

Further advantages and embodiments are evident from the accompanying drawings. In the drawings:

FIG. 1 shows a structure diagram of Bluetooth antenna of common RF coaxial cable in the embodiment of the present invention.

FIG. 2 shows the cross section diagram of the common section of the Bluetooth antenna of common RF coaxial cable in the embodiment of the present invention.

FIG. 3 shows a schematic diagram of the standing-wave antenna formed by the Bluetooth antenna of common RF coaxial cable in the embodiment of the present invention.

### DESCRIPTIONS OF THE PREFERRED EMBODIMENT

The present invention will be further illustrated in combination with the following figures and embodiments, but it should not be deemed as limitation of the present invention.

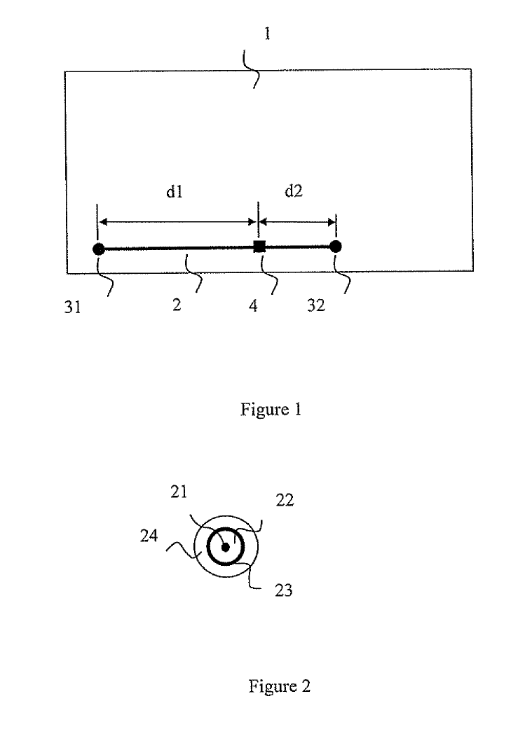

As referred in FIG. 1, the present invention Bluetooth antenna of common RF coaxial cable 2, comprising: a RF coaxial cable 2 including a first RF interface 31 and a second RF interface 32, two ends of the RF coaxial cable 2 are respectively connected to the first RF interface 31 and the second RF interface 32.

In the preferred embodiment of the present invention, the RF coaxial cable 2 is placed on a PCB 1, more particularly, the RF coaxial cable 2 is located at the edge of the surface of the PCB 1. The middle of the PCB 1 is used for placing the batteries and the other elements, the PCB is likely to be covered with the other elements with metal surface even unoccupied space is available in the PCB 1, which would decrease the efficiency.

The total length of the RF coaxial cable 2 is odd times of one quarter of the Bluetooth resonant wavelength, preferably, the total length of the RF coaxial cable 2 is three-quarters of the Bluetooth resonant wavelength.

The RF coaxial cable 2 is provided with a feed point 4. As shown in FIG. 1, the distance d1 from the feed point 4 to the first RF interface 31 is even times of one quarter of the Bluetooth resonant wavelength, and the distance d2 from the feed point 4 to the second RF interface 32 is odd times of one quarter of the Bluetooth resonant wavelength. Preferably, the distance d1 from the feed point 4 to the first RF interface 31 is one half of the Bluetooth resonant wavelength, and the distance from the feed point 4 to the second RF interface 32 is one quarter of the Bluetooth resonant wavelength.

As referred in FIG. 2, the structure of the RF coaxial cable 2 is consisted of an inner conductor 21, an inner insulator 22, an outer conductor 23 and an outer insulator 24 from the inside out. The outer conductor 23 is provided with two ground connection. Preferably, the outer conductor 23 is connected to the ground at the joint of the first RF interface 31 and the joint of the second RF interface 32 respectively. The feed point 4 is connected to the outer conductor 23. Preferably, as shown in FIG. 1, the PCB 1 is a rectangle shape, the first RF interface 31 is adjacent to the corner of the PCB 1.

According to the theory of transmission lines:

$${Z}_{in} = {Z}_{0} \frac{{Z}_{L} + {jZ}_{0} tan β 1}{{Z}_{0} + {jZ}_{L} tan β 1} \qquad ( 1 )$$

In which: Zᵢₙ means input impedance, Z₀ means characteristic impedance of the loss-free transmission lines, Z_{L} means load impedance (L refers to Load),

$$β = \frac{2 π}{λ} ,$$

l means length. When in short circuit, Z_{L}=0, then:

$${Z}_{in} = {Z}_{0} \frac{{Z}_{L} + {jZ}_{0} tan β 1}{{Z}_{0} + {jZ}_{L} tan β 1} = {jZ}_{0} tan β 1$$

When d2 is one quarter of the Bluetooth resonant wavelength, then:

The value of

$${Z}_{in} = {jZ}_{0} tan β 1 = {jZ}_{0} tan ( \frac{2 π}{λ} * \frac{λ}{4} )$$

would tends to be infinite, which can be regarded as open circuit. When d1 is even times of one quarter of the Bluetooth resonant wavelength, here the multiple is assume to be two times which can be divided into two quarters, one end of the coaxial cable is connected to the ground, another end is feed point. In view from the middle point to the ground point, it is an infinite impedance in parallel connection, which equivalent to open circuit and it can be simplified as the module that the length from the feed point to the middle point is one quarter of the Bluetooth resonant wavelength and it belongs to open circuit after the middle point. The above-mentioned is the representative example of the half wave dipole. The radiation impedance in formula (1) can be R+jX, wherein R means the real part of impedance and the imaginary part means reactance X.

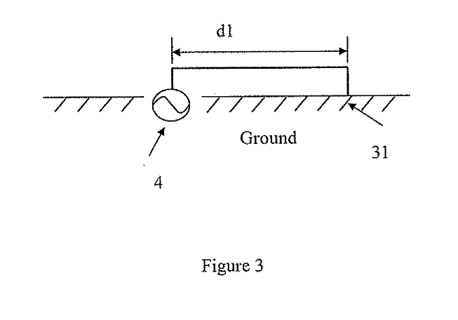

As for the feed point 4 of the Bluetooth antenna, the second RF interface is connected to the ground which forms a short circuit, then the RF coaxial cable at the feed point 4 of the Bluetooth antenna is equivalent to a open circuit, wherein the length d2 of the RF coaxial cable the is one quarter of the Bluetooth resonant wavelength. Thus, there is no electromagnetic radiation involved, and it would not be regarded as the radiator of the Bluetooth antenna. The Bluetooth antenna feed-in the signal from the feed point 4, the outer conductor of the section of the RF coaxial cable which connects the feed point 4 to the ground RF interface 31 is worked as the radiator of the Bluetooth antenna. The length d1 of the outer conductor of the RF coaxial cable is one half of the Bluetooth resonant wavelength, which forms a standing-wave antenna. As shown in FIG. 3, a resonance is created at the Bluetooth standard working frequency (2.4 GHz˜2.5 GHz) in order to meet the radiance requests of general communication Bluetooth antenna.

The present invention takes the outer conductor as the radiator of the Bluetooth antenna. The RF coaxial cable can still be utilized for transferring RF signal, so that the Bluetooth antenna can be worked with the RF coaxial cable at the same time, which decreases the size of the antenna and achieve the goal of decreasing the size of the whole communication terminal.

The present invention provides a communication terminal, the communication terminal is provided with one of aforesaid Bluetooth antenna, since any one of the Bluetooth antenna possess the above-mentioned technical effects, thereby the communication terminal provided with the Bluetooth terminal also possess the corresponding technical effects, the particular implementation is similar to the above-mentioned embodiments which would not be described.

It is obvious for the skilled in the art to make varieties of changes and modifications after reading the above descriptions. Hence, the Claims attached should be regarded as all the changes and modifications which cover the real intention and the range of this invention. Any and all equivalent contents and ranges in the range of the Claims should be regarded belonging to the intention and the range of this invention.

1.-10. (canceled)

11. A Bluetooth antenna of common RF coaxial cable (2), comprising: an RF coaxial cable (2) including a first RF interface (31) and a second RF interface (32), two ends of the RF coaxial cable (2) are respectively connected to the first RF interface (31) and the second RF interface (32), the RF coaxial cable (2) is provided with a feed point (4), wherein the total length of the RF coaxial cable (2) is odd times of one quarter of the Bluetooth resonant wavelength.

12. Bluetooth antenna of common RF coaxial cable (2) as disclosed in claim 11, wherein the total length of the RF coaxial cable (2) is odd times of three-quarters of the Bluetooth resonant wavelength.

13. The Bluetooth antenna of common RF coaxial cable (2), comprising: a RF coaxial cable (2) including a first RF interface (31) and a second RF interface (32), two ends of the RF coaxial cable (2) are respectively connected to the first RF interface (31) and the second RF interface (32), the RF coaxial cable (2) is provided with a feed point (4), wherein the distance from the feed point (4) to the first RF interface (31) is even times of one quarter of the Bluetooth resonant wavelength.

14. The Bluetooth antenna of common RF coaxial cable (2) as disclosed in claim 13, wherein the distance from the feed point (4) to the first RF interface (31) is one half of the Bluetooth resonant wavelength.

15. The Bluetooth antenna of common RF coaxial cable (2), comprising: a RF coaxial cable (2) including a first RF interface (31) and a second RF interface (32), two ends of the RF coaxial cable (2) are respectively connected to the first RF interface (31) and the second RF interface (32), the RF coaxial cable (2) is provided with a feed point (4), wherein the distance from the feed point (4) to the second RF interface (32) is odd times of one quarter of the Bluetooth resonant wavelength.

16. The Bluetooth antenna of common RF coaxial cable (2) as disclosed in claim 15, wherein the distance from the feed point (4) to the second RF interface (32) is one quarter of the Bluetooth resonant wavelength.

17. The Bluetooth antenna of common RF coaxial cable (2) as disclosed in claim 11, wherein the structure of the RF coaxial cable (2) is consisted of an inner conductor (21), an inner insulator (22), an outer conductor (23) and an outer insulator (24) from the inside out.

18. The Bluetooth antenna of common RF coaxial cable (2), comprising: a RF coaxial cable (2) including a first RF interface (31) and a second RF interface (32), two ends of the RF coaxial cable (2) are respectively connected to the first RF interface (31) and the second RF interface (32), the RF coaxial cable (2) is provided with a feed point (4), wherein the structure of the RF coaxial cable (2) is consisted of an inner conductor (21), an inner insulator (22), an outer conductor (23) and an outer insulator (24) from the inside out, and wherein the outer conductor (23) is provided with two ground connections.

19. The Bluetooth antenna of common RF coaxial cable (2) as disclosed in claim 18, wherein the outer conductor (23) is connected to the ground at the joint of the first RF interface (31) and the joint of the second RF interface (32) respectively.

20. The Bluetooth antenna of common RF coaxial cable (2) as disclosed in claim 18, wherein the feed point (4) is connected to the outer conductor (23).

21. The Bluetooth antenna of common RF coaxial cable (2) as disclosed in claim 11, wherein the RF coaxial cable (2) is placed on a PCB with a rectangle shape, the first RF interface (31) is adjacent to the corner of the PCB.

22. A communication terminal, comprising a Bluetooth antenna of common RF coaxial cable, wherein the Bluetooth antenna of common RF coaxial cable comprises: an RF coaxial cable (2) including a first RF interface (31) and a second RF interface (32), two ends of the RF coaxial cable (2) are respectively connected to the first RF interface (31) and the second RF interface (32), the RF coaxial cable (2) is provided with a feed point (4), wherein the total length of the RF coaxial cable (2) is odd times of one quarter of the Bluetooth resonant wavelength.

23. The communication terminal as disclosed in claim 22, wherein the total length of the RF coaxial cable (2) is odd times of three-quarters of the Bluetooth resonant wavelength.

24. The communication terminal as disclosed in claim 22, wherein the distance from the feed point (4) to the first RF interface (31) is even times of one quarter of the Bluetooth resonant wavelength.

25. The communication terminal as disclosed in claim 24, wherein the distance from the feed point (4) to the first RF interface (31) is one half of the Bluetooth resonant wavelength.

26. The communication terminal as disclosed in claim 22, wherein the distance from the feed point (4) to the second RF interface (32) is odd times of one quarter of the Bluetooth resonant wavelength.

27. The communication terminal as disclosed in claim 26, wherein the distance from the feed point (4) to the second RF interface (32) is one quarter of the Bluetooth resonant wavelength.

28. The communication terminal as disclosed in claim 22, wherein the structure of the RF coaxial cable (2) is consisted of an inner conductor (21), an inner insulator (22), an outer conductor (23) and an outer insulator (24) from the inside out.

29. The communication terminal as disclosed in claim 28, wherein the outer conductor (23) is provided with two ground connections.

30. The communication terminal as disclosed in claim 29, wherein the outer conductor (23) is connected to the ground at the joint of the first RF interface (31) and the joint of the second RF interface (32) respectively.

31. The communication terminal as disclosed in claim 29, wherein the feed point (4) is connected to the outer conductor (23).

32. The communication terminal as disclosed in claim 22, wherein the RF coaxial cable (2) is placed on a PCB with a rectangle shape, the first RF interface (31) is adjacent to the corner of the PCB.
